(19) United States
(12) Patent Application Publication
(10) Pub. No.: US 2026/0041183 A1
(43) Pub. Date: Feb. 12, 2026

(54) ADHESIVE FOR COSMETIC ARTICLE AND METHOD OF FORMING

(71) Applicant: H.B. Fuller Company, St. Paul, MN (US)

(72) Inventors: Haiying Zhou, Arden Hills, MN (US); Jing Tang, St. Paul, MN (US); Westley S. Bauer, Minneapolis, MN (US); Kimberly M. Tucker, Morganton, NC (US)

(21) Appl. No.: 19/290,697

(22) Filed: Aug. 5, 2025

Related U.S. Application Data
(60) Provisional application No. 63/680,433, filed on Aug. 7, 2024.

(51) Int. Cl. A41G 5/02; C08K 5/13; C08K 5/134; C09J 5/00; C09J 11/06; C09J 135/04

(52) U.S. Cl. CPC A41G 5/02; C09J 5/00; C09J 11/06; C09J 135/04; C08K 5/13; C08K 5/1345; C09J 2433/00; C09J 2489/008

(57) ABSTRACT

A method of applying a cosmetic article. The method includes applying an adhesive composition to at least one of a keratin-containing substrate and a cosmetic article. The method includes positioning the other of the keratin-containing substrate and cosmetic article in direct contact with the adhesive composition such that the keratin-containing substrate and cosmetic article are attached to one another through the adhesive composition. The adhesive composition includes a cyanoacrylate composition, and from 0.05% to five % by weight an additive composition comprising at least one substituted catechol group, based on the total weight of the adhesive composition.

### CROSS REFERENCE TO RELATED APPLICATIONS

This application claims the benefit of U.S. Provisional Application No. 63/680,433, filed Aug. 7, 2024, which is incorporated herein.

### FIELD

The present disclosure relates to adhesive compositions suitable for bonding items to a keratin-containing substrate. In particular, the present disclosure relates to adhesive compositions suitable for bonding cosmetic articles to a human or animal, keratin-containing substrate.

### BACKGROUND

Cosmetic articles, such as fake eyelashes, fake fingernails or toenails, and hair extensions, can be attached to a human or animal body part by an adhesive. Various adhesives are available that can bond a cosmetic article to a body part. For example, there may be adhesives for bonding a fake eyelash to a human eyelash, bonding a fake fingernail or nail extension to a human fingernail, or bonding a fake hair such as a hair extension to human hair.

There are disadvantages to the adhesives currently available for bonding cosmetic articles to a human or animal body part. Low bond strength is one disadvantage of such adhesives currently available. Low bond strength can lead to a cosmetic article becoming detached from the substrate that it is attached to sooner than desired.

There is a need for an adhesive that can be used to attach a cosmetic article to a body part and that provides the desired bond strength. There is a need for an adhesive that can be used to attach a cosmetic article to a body part easily, such as using an at-home type process for attaching one or more eyelash extensions, which can overcome one or more the foregoing disadvantages of available adhesives for attaching one or more eyelash extensions.

### SUMMARY

Disclosed herein is a method of applying a cosmetic article. The method includes applying an adhesive composition to at least one of a keratin-containing substrate and a cosmetic article. The method includes positioning the other of the keratin-containing substrate and cosmetic article in direct contact with the adhesive composition such that the keratin-containing substrate and cosmetic article are attached to one another through the adhesive composition. The adhesive composition includes a cyanoacrylate composition, and from 0.05% to five % by weight an additive composition comprising at least one substituted catechol group, based on the total weight of the adhesive composition.

In some aspects, the adhesive composition includes from 0.1% to five % by weight the additive composition, based on the total weight of the adhesive composition. In some aspects, the adhesive composition includes from 0.1% to one % by weight the additive composition, based on the total weight of the adhesive composition. In some aspects, the adhesive composition includes from 0.1% to 0.5% by weight the additive composition, based on the total weight of the adhesive composition. In some aspects, the adhesive composition includes from 0.2% to 0.5% by weight the additive composition, based on the total weight of the adhesive composition. In some aspects, the keratin-containing substrate is at least one from the group of eyelash, hair, fingernail, toenail, tooth, and area of skin. In some aspects, the cosmetic article is at least one from the group of artificial eyelash, hair extension, wig, artificial fingernail, artificial toenail, and prosthetic facial artifact.

In some aspects, the cyanoacrylate composition includes at least one monomer from the group of butyl cyanoacrylate, hexyl cyanoacrylate, ethyl cyanoacrylate, octyl cyanoacrylate, methoxyethyl cyanoacrylate, and ethoxyethyl cyanoacrylate. In some aspects, the adhesive composition is configured to exhibit a bond strength of at least 130 gF/mm between the keratin-containing substrate and cosmetic article when measured in accordance with the Bond Strength Test Method. In some aspects, the step of positioning includes the keratin-containing substrate and cosmetic article being attached to one another through the adhesive composition such that the adhesive composition exhibits a bond strength of at least 130 gF/mm between the keratin-containing substrate and cosmetic article when measured in accordance with the Bond Strength Test Method.

In some aspects, the cyanoacrylate composition includes monomers represented by Formula V:

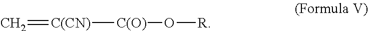

wherein “R” is at least one from the group of alkyl group, a C1-C14 substituted group, and allyl group.

In some aspects, the alkyl group is at least one from the group of methyl, ethyl, propyl, butyl, pentyl, hexyl, heptyl, octyl, decyl, undecyl, decyl, dodecyl, tridecyl, tetradecyl, pentadecyl, hexadecyl, and alkoxy-alkyl group. In some aspects, alkoxy-alkyl group is at least one from the group of 2-methoxyethyl and 2-ethoxy ethyl, 3-methoxybutyl, 2-butoxyethyl, 2-isopropoxyethyl, and 1-methoxy-2-propyl.

In some aspects, the additive composition comprises at least one acid substituted catechol group. In some aspects, the additive composition includes at least one from the group of tannic acid, caffeic acid, propyl gallate, and 3,4-dihydroxyhydrocinnamic acid. In some aspects, the additive composition comprises at least one substituted catechol group.

Disclosed herein is a method of applying an artificial eyelash. The method includes applying an adhesive composition to at least one of a natural eyelash and an artificial eyelash. The method includes positioning the other of the natural eyelash and artificial eyelash in direct contact with the applied adhesive such that the natural eyelash and the artificial eyelash are attached to one another through the adhesive composition. The adhesive composition comprises a cyanoacrylate composition and from 0.05% to five % by weight an additive composition comprising at least one substituted catechol group, based on the total weight of the adhesive composition. In some aspects, the adhesive composition includes from 0.1% to five % by weight the additive composition, based on the total weight of the adhesive composition. In some aspects, the adhesive composition includes from 0.1% to two % by weight the additive composition, based on the total weight of the adhesive composition. In some aspects, the adhesive composition includes from 0.1% to one % by weight the additive composition, based on the total weight of the adhesive composition. In some aspects, the adhesive composition includes from 0.1% to 0.5% by weight the additive composition, based on the total weight of the adhesive composition. In some aspects, the adhesive composition includes from 0.2% to 0.5% by weight the additive composition, based on the total weight of the adhesive composition.

In some aspects, the cyanoacrylate composition includes at least one from the group of butyl cyanoacrylate and ethyl cyanoacrylate. In some aspects, the additive composition includes at least one from the group of tannic acid, caffeic acid, propyl gallate, and 3,4-dihydroxyhydrocinnamic acid. In some aspects, the adhesive composition is configured to exhibit a bond strength of at least 130 gF/mm between the natural eyelash and artificial eyelash when measured in accordance with the Bond Strength Test Method.

In some aspects, the step of positioning includes the natural eyelash and artificial eyelash being adhered to one another through the adhesive composition such that the adhesive composition exhibits a bond strength of at least 130 gF/mm between the natural eyelash and artificial eyelash when measured in accordance with the Bond Strength Test Method.

Disclosed herein is an artificial lash extension system that includes a plurality of lash extensions, each lash extension of the plurality of lash extensions being configured to be attached to a surface of at least one natural eyelash. The system includes an adhesive composition that includes a cyanoacrylate composition; and from 0.05% to 0.5% by weight an additive composition comprising at least one substituted catechol group, based on the total weight of the adhesive composition. In some aspects, the adhesive composition includes from 0.1% to five % by weight the additive composition, based on the total weight of the adhesive composition. In some aspects, the adhesive composition includes from 0.1% to one % by weight the additive composition, based on the total weight of the adhesive composition. In some aspects, the adhesive composition includes from 0.1% to 0.5% by weight the additive composition, based on the total weight of the adhesive composition. In some aspects, the adhesive composition includes from 0.2% to 0.5% by weight the additive composition, based on the total weight of the adhesive composition. In some aspects, the cyanoacrylate composition includes at least one from the group of butyl cyanoacrylate and ethyl cyanoacrylate.

In some aspects, the additive composition includes at least one from the group of tannic acid, caffeic acid, propyl gallate, and 3,4-dihydroxyhydrocinnamic acid. In some aspects, the adhesive composition is configured to exhibit a bond strength of at least 130 gF/mm between at least one lash extension of the plurality of lash extensions and at least one natural eyelash when measured in accordance with the Bond Strength Test Method.

Disclosed herein is a method of applying a cosmetic article. The method includes applying an adhesive composition to at least one of a keratin-containing substrate and a cosmetic article. The method includes positioning the other of the keratin-containing substrate and cosmetic article in direct contact with the applied adhesive composition such that the keratin-containing substrate and cosmetic article are attached to one another through the adhesive composition. The adhesive composition includes a cyanoacrylate composition, and from 0.05% to 0.5% by weight an additive composition, based on the total weight of the adhesive composition. In some aspects, the adhesive composition includes from 0.1% to five % by weight the additive composition, based on the total weight of the adhesive composition. In some aspects, the adhesive composition includes from 0.1% to one % by weight the additive composition, based on the total weight of the adhesive composition. In some aspects, the adhesive composition includes from 0.1% to 0.5% by weight the additive composition, based on the total weight of the adhesive composition. In some aspects, the adhesive composition includes from 0.2% to 0.5% by weight the additive composition, based on the total weight of the adhesive composition. The additive composition comprises at least one substituted catechol group.

In some aspects, the cyanoacrylate composition includes at least one from the group of butyl cyanoacrylate and ethyl cyanoacrylate. In some aspects, the additive composition includes at least one from the group of tannic acid, caffeic acid, propyl gallate, and 3,4-dihydroxyhydrocinnamic acid. In some aspects, the adhesive composition is configured to exhibit a bond strength of at least 130 gF/mm between the keratin-containing substrate and cosmetic article when measured in accordance with the Bond Strength Test Method.

In some aspects, the step of positioning includes the keratin-containing substrate and cosmetic article being adhered to one another through the adhesive composition such that the adhesive composition exhibits a bond strength of at least 130 gF/mm between the keratin-containing substrate and cosmetic article when measured in accordance with the Bond Strength Test Method.

These embodiments are intended to be within the scope of the invention disclosed herein. These and other embodiments of the present invention will become readily apparent to those skilled in the art from the following detailed description of the various embodiments having reference to the attached FIGURES, the invention not being limited to any particularly preferred embodiment(s) disclosed. Other features and advantages will be apparent from the following brief description of the drawings (where like reference numbers and designations in the various drawings indicate like elements), the description of the preferred embodiments, and from the claims.

### Glossary

As used here, a “cosmetic article” is defined as an article configured to be positioned on, along, or otherwise in contact with a portion of a human or animal body, such as by affixing it to a human or animal body part, for one or both of highlighting a feature of that portion of the body and altering the appearance of that portion of the body. This includes, for example, an article positioned on a portion of the body part to change the perceived size, shape, brilliance, color, or dimension of that portion of the body.

As used herein, a “keratin-containing substrate” is defined as a substrate formed from a material that contains keratin as a component of the composition of the material.

As used herein, a “fake eyelash” is defined as one or more strands of a material that is suitable for attachment to a live body part for resembling and/or enhancing the appearance of a live eyelash.

As used herein, a “live” (used in the adjective form) item, such as a “live eyelash,” is defined as one or more items (e.g., an eyelash or a plurality of eyelashes) that is a portion of a human or animal body.

As defined herein a “substituted catechol group” is defined as the structure represented by Formula I.

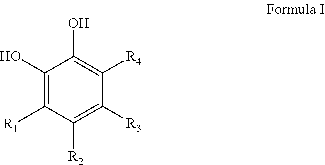

Wherein any of R₁ to R₄ in Formula I may be a hydrogen or a hydroxyl group, and wherein at least one of R₁ to R₄ is any non-basic linear, branched, cyclic, or fused substituent.

A “non-basic substituent” is defined as having pkb of <14.0.

### DETAILED DESCRIPTION

Disclosed herein is an adhesive composition suitable for bonding one or more cosmetic articles to a human or animal body part. Disclosed herein is a method of bonding one or more cosmetic articles to a human or animal body part using the adhesive compositions disclosed herein.

In certain embodiments, the adhesive composition includes, consists essentially of, or consists of, a cyanoacrylate composition and an additive composition. In certain embodiments, the adhesive composition includes, consists essentially of, or consists of, at least one cyanoacrylate composition and an additive composition that includes at least one substituted catechol group.

The adhesive composition is suitable for bonding a cosmetic article to a keratin-containing substrate. For example, the adhesive composition is suitable for bonding a cosmetic article to a keratin-containing body part.

The adhesive composition having a cyanoacrylate composition with the additive composition exhibits an improved bond strength compared to a cyanoacrylate composition free of an additive composition. In some embodiments, the adhesive composition having a cyanoacrylate composition with the additive composition exhibits a bond strength of at least 130 gF/mm between a keratin-containing substrate and cosmetic article when measured in accordance with the Bond Strength Test Method.

### Cyanoacrylate Composition

The adhesive composition includes a cyanoacrylate composition. Suitable cyanoacrylate compositions can include at least one of butyl cyanoacrylate, hexyl cyanoacrylate, ethyl cyanoacrylate, octyl cyanoacrylate, methoxyethyl cyanoacrylate, and ethoxyethyl cyanoacrylate. For example, suitable cyanoacrylate compositions can include monomers of at least one from the group of butyl cyanoacrylate, ethyl cyanoacrylate, octyl cyanoacrylate, methoxyethyl cyanoacrylate, and ethoxyethyl cyanoacrylate.

In some embodiments, the cyanoacrylate composition includes one or more monomers represented by Formula V:

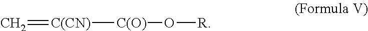

wherein “R” includes, is selected from the group consisting essentially of, or is selected from the group consisting of, an alkyl group (such as a C1-C14 substituted group (e.g., methyl, ethyl, propyl, butyl, pentyl, hexyl, heptyl, octyl, decyl, undecyl, decyl, dodecyl, tridecyl, tetradecyl, pentadecyl, hexadecyl group)); or an alkoxy-alkyl group (such as 2-methoxyethyl, 2-ethoxy ethyl, 3-methoxybutyl, 2-butoxyethyl, 2-isopropoxyethyl, and 1-methoxy-2-propyl); or an allyl group.

In some embodiments, suitable cyanoacrylate compositions may be those commercially available under the trade designations SCOTCH-WELD (from 3M, of St. Paul, MN, USA), LOCTITE (from Henkel Corporation, of Chanhassen, MN, USA), MXBON (such as the MXBON series, available from Cartell Chemical Co., Ltd. of Chia-Yi, Taiwan), HYLOC (from Xtraloc Ltd, of Runcorn, England), and ALTECO (from Alteco, USA, Inc., of Torrance, CA, USA). In some embodiments, suitable cyanoacrylate monomers, such as ethyl cyanoacetate, butyl cyanoacrylate, octyl cyanaoacrylate, ethoxyethyl cyanoacrylate, and methoxyethyl cyanoacrylate monomers, may be commercially available from Hebei Chengxin Co., Ltd (of Shijiazhuang City, China), Cartell Chemical Co., Ltd. of (Chia-Yi, Taiwan), or Koatsu Gas Kogyo Co., Ltd. (of Osaka, Japan).

### Additive Composition

Suitable additive compositions can include at least one substituted catechol group, as defined herein. For example, referring to the structure represented by Formula I, R₁ to R₄ may be alkyl (e.g., C1-C12, such as methyl, ethyl, propyl, butyl, and isomers thereof), alkenyl, alkynl, aryl, acyl, or acyl derivatives (e.g., ester, cyclic ester, thioester, anhydride, acyl phosphate, acyl halide, carbamate, and amide) epoxy, acrylic, ether, silane, nitrile, ketone, and/or ionic.

In some embodiments, suitable additive compositions can include those formed synthetically. In some embodiment, suitable additive compositions can include those formed by a natural process, for example, bio-based components, such as components produced by living organisms.

In some embodiments, suitable additive compositions can include at least one substituted catechol group having at least two hydroxyl groups in the para position. In some embodiments, suitable additive compositions can include catechol-containing phenolics. In some embodiments, suitable additive compositions can include at least one substituted catechol group and the additive composition can have a number average molecular weight of at least 120, of at least 200, at least 300, at least 400, or even at least 1000.

In some embodiments, suitable additive compositions can include polystyrenes, polylactic acids, and polymethacrylates.

In some embodiments, suitable additive compositions can include at least one of tannic acid, caffeic acid, propyl gallate, and 3,4-dihydroxyhydrocinnamic acid. In some embodiments, the additive composition may be selected from the group consisting of tannic acid, caffeic acid, propyl gallate, and 3,4-dihydroxyhydrocinnamic acid. For example, suitable additive compositions may include tannic acid, such as that represented by the structure shown here.

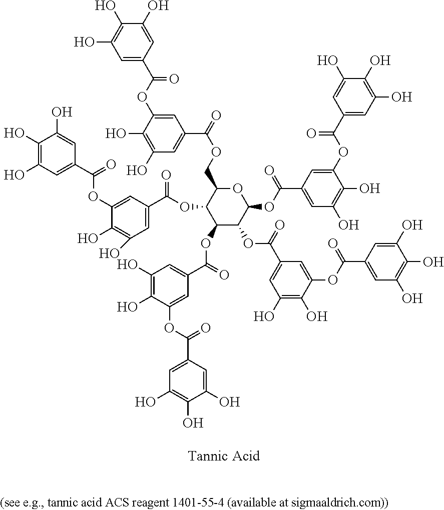 [SMILES: O=C(OC[C@H]1O[C@@H](OC(=O)c2cc(O)c(O)c(OC(=O)c3cc(O)c(O)c(O)c3)c2)[C@H](OC(=O)c2cc(O)c(O)c(OC(=O)c3cc(O)c(O)c(O)c3)c2)[C@@H](OC(=O)c2cc(O)c(O)c(OC(=O)c3cc(O)c(O)c(O)c3)c2)[C@@H]1OC(=O)c1cc(O)c(O)c(OC(=O)c2cc(O)c(O)c(O)c2)c1)c1cc(O)c(O)c(OC(=O)c2cc(O)c(O)c(O)c2)c1]

The adhesive composition includes the additive composition in an amount from 0.01 wt. %, 0.05, 0.08, 0.1, 0.2, 0.3, 0.4, 0.5, 0.6, 0.7, 0.8, 0.9, or even one wt. %, to 1.5 wt. %, two, 2.5, three, 3.5, four, 4.5 or even five wt. %, based on the total weight of the adhesive composition, or a weight percentage between any pair of the foregoing values. For example, the adhesive composition can include the additive composition in an amount from 0.01 wt. % to five wt. %, 0.05 wt. % to five wt. %, 0.05 wt. % to five wt. %, 0.05 wt. % to four wt. %, 0.05 wt. % to three wt. %, 0.05 wt. % to two wt. %, 0.05 wt. % to one wt. %, 0.1 wt. % to five wt. %, 0.1 wt. % to four wt. %, 0.1 wt. % to three wt. %, 0.1 wt. % to two wt. %, 0.1 wt. % to one wt. %, 0.1 wt. % to 0.9 wt. %, 0.1 wt. % to 0.8 wt. %, 0.1 wt. % to 0.7 wt. %, 0.1 wt. % to 0.6 wt. %, 0.1 wt. % to 0.5 wt. %, 0.1 wt. % to 0.4 wt. %, 0.1 wt. % to 0.3 wt. %, or even 0.1 wt. % to 0.2 wt. %, 0.2 wt. % to five wt. %, 0.2 wt. % to four wt. %, 0.2 wt. % to three wt. %, 0.2 wt. % to two wt. %, 0.2 wt. % to one wt. %, 0.2 wt. % to 0.9 wt. %, 0.2 wt. % to 0.8 wt. %, 0.2 wt. % to 0.7 wt. %, 0.2 wt. % to 0.6 wt. %, 0.2 wt. % to 0.5 wt. %, 0.2 wt. % to 0.4 wt. %, or even 0.2 wt. % to 0.3 wt. %, based on the total weight of the adhesive composition.

### Further Components

The adhesive composition can include further components such as thickeners, stabilizers, and accelerators.

For example, in certain embodiments, suitable thickeners may include one or more of polycyanoacrylate, polymethyl methacrylate, polyethylhexyl methacrylate, polyvinylacetate, polyurethane, polycaprolactone, lactic-glycolic acid copolymer, lactic acid-caprolactone copolymer, polyorthoesters, polyalkyl acrylate, copolymers of alkylacrylate and vinyl acetate, polyalkyl methacrylates, copolymers of alkyl methacrylates and butadiene, polyoxalate, triblock copolymers of polyoxypropylene, poloxamers, treated or untreated fumed silica, quartz, synthetic mica, calcium silicate, magnesium silicate, strontium silicate, and/or zeolite.

In certain embodiments, suitable accelerators may include one or more of calixarene, oxacalixarenes, silacrowns, crown ethers, cyclodextrin and its derivatives, poly(ethyleneglycol) di(meth), acrylates, ethoxylated hydric compounds, polyethers, aliphatic alcohol, aliphatic carboxylic acid esters, benzoyl peroxide, amine compounds (such as triethyl amine, diethyl amine, butyl amine, isopropyl amine, tributyl amine, N,N,-dimethyl aniline, N,N-diethyl aniline, N,N-dimethyl-p-toluidine, N,N-dimethyl-m-toluidine, N,N-dimethyl-o-toluidine, dimethyl benzyl amine, pyridine, picoline, vinyl pyridine, ethanolamine, propanolamine and ethylene diamine), ammonium salts (such as alkyl ammonium salts, amide-bonded ammonium salts, ester-bonded ammonium salts, ether-bonded ammonium salts and alkylimidazolinium salts), cyclosulfur compounds and derivatives thereof, and polyalkylene oxides, and derivatives and combinations thereof.

In certain embodiments, suitable stabilizers may include one or more of free radical stabilizers and anionic stabilizers, such as butylated hydroxyanisole, hydroquinone, phenolic antioxidant, butyl hydroxy toluene, other hydroquinone monomethyl ether and hindered phenols, 4-ethoxyphenol, 4-methoxyphenol; 3-methoxyphenol; 2-tertbutyl-4-methoxyphenol; 2-tert-butyl-4-methoxyphenol; 2,2-methylene-bis-(4-methyl-6-tert-butylphenol), sulfur dioxide, sulfonic acids, sulfuric acid, sulfur trioxide, phosphorous acids, carboxylic acids, picric acid, boron trifluoride, BF3-ether complexes, citric acid, hydrofluoric acid, tin (IV) chloride, iron (III) chloride, and combinations thereof.

The adhesive composition can optionally include one or more of plasticizers, colorants, and bioactive ingredients.

In certain embodiments, suitable plasticizers may include one or more of tributyl citrate (TBC), acetyl tributyl citrate (ATBC), dimethyl sebacate, diethyl sebacate, dibutyl sebacate, triethyl phosphate, tri(2-ethyl-hexyl)phosphate, tri(p-cresyl)phosphate, diisodecyl adipate (DIDA), glyceryl triacetate, glyceryl, tributyrate, dioctyl adipate (DICA), isopropyl myrisate, butyl sterate, lauric acid, trioctyl trimelliate, dioctyl glutatrate, (DICG), and combinations thereof.

In certain embodiments, suitable colorants may include one or more of organic dyes and inorganic pigments, for example, carbon black, CI77266, iron oxide, CI77499, FD&C Blue No. 1, D&C Green No. 5, FD&C Yellow No. 5, FD&C Red No. 40, carmine, and combinations thereof.

### Cosmetic Article

The adhesive compositions disclosed herein can be suitable for bonding one or more cosmetic articles to a human or animal body part, for example bonding one or more artificial eyelash, hair extension, wig, artificial fingernail, artificial toenail, and/or prosthetic facial artifact. In some embodiments, a prosthetic facial artifact could include an artificial nose or portion of a nose, a moustache, lip or lips or portions of such, eyelid, eyebrow, ear or a portion of an ear, or an artificial cosmetic feature (e.g., artificial skin and/or flesh, such as to enhance the prominence, shape or size of a body part, or to give the appearance of a wound).

In some embodiments, a cosmetic article may be formed from a synthetic material. In some embodiments, a cosmetic article may be formed from a material that was previously a live article. For example, in some instances an artificial eyelash may be an eyelash that was previously a live eyelash or may be formed from one or more strands of human or animal hair that was previously live. In some instances, an artificial eyelash may be combinations of a synthetic and previously live eyelash such as a previously live eyelash that has been combined with synthetic material to increase the length or diameter of the previously live eyelash.

The adhesive compositions disclosed herein can be suitable for bonding one or more cosmetic articles to a keratin-containing substrate such as a keratin-containing human or animal body part. A keratin-containing substrate is defined above and can include, for example, a “live” (used herein in the adjective form of speech) body part such as an eyelash, hair, portion of skin, fingernail, toenail, or tooth. Generally, a “live” body part refers to a body part that is a section of a human or animal body such that the body part is connected to the remaining portions of the body and in some cases still growing. For example, a live eyelash, hair, fingernail, toenail, and area of skin may be an eyelash, hair, fingernail, toenail, or area of skin that is still a part of a human or animal body and is still a natural part of the body, such as still being provided with additional cells and continuing to grow.

In some embodiments, the adhesive composition having a cyanoacrylate composition with the additive composition exhibits a bond strength of at least 130 gF/mm between a keratin-containing substrate and cosmetic article when measured in accordance with the Bond Strength Test Method. For example, the adhesive composition can exhibit a bond strength of at least 130, 140, 150, 160, 170, 180, 190, 200, 210, 220, 230, 240, 250, 260, 270, 280, 290, 300, 310, 320, 330, 340, or even at least 350 gF/mm when measured in accordance with the Bond Strength Test Method. In some embodiments, the adhesive composition having a cyanoacrylate composition with the additive composition can exhibit a bond strength of at least 130, 140, 150, 160, 170, 180, 190, 200, 210, 220, 230, 240, 250, 260, 270, 280, 290, 300, 310, 320, 330, 340, or even at least 350 gF/mm between a keratin-containing substrate and cosmetic article when measured in accordance with the Bond Strength Test Method.

In some embodiments, the adhesive composition having a cyanoacrylate composition and the additive composition exhibits an increase of at least 9%, at least 10%, at least 20%, at least 30%, at least 40%, at least 50%, at least 60%, at least 70%, or even at least 80% in the bond strength between a keratin-containing substrate and cosmetic article when measured in accordance with the Bond Strength Test Method compared to an adhesive composition having a cyanoacrylate composition and free of the additive composition.

### Application Method

Disclosed herein is a process for applying an adhesive composition that is made of cyanoacrylate composition and is safe for use in contact with a human body part. The cyanoacrylate composition exhibits a fast bonding time so that a process for bonding a cosmetic article is suitable for use, such as with an at-home process, for instance to be applied by hand in a salon or spa, or by a user assisting the wearer of the cosmetic article (e.g., a make-up artist).

The adhesive composition is easy to apply. An example application process can include applying an adhesive composition to at least one of a natural eyelash and an artificial eyelash. For example, the adhesive composition can be applied by holding a strand of an artificial eyelash at a first end of the strand, and inserting the second end of the strand into a bubble of the adhesive composition. Additionally, or alternatively, the adhesive composition can be wiped (e.g., with a brush) or dropped onto the second end of the strand.

The strand of the artificial eyelash can then be contacted to the live eyelash of a wearer such that the adhesive composition that was placed on the artificial eyelash is contacting the live eyelash. The adhesive composition can then be allowed to cure (e.g., at room temperature) such that after curing, the artificial eyelash and the live eyelash are attached to one another through the adhesive composition,

In another example, an example application process can include applying an adhesive composition to a live fingernail (such as with a brush or by dropping a suitable amount of the adhesive composition onto the live fingernail). An artificial fingernail (e.g., a fingernail extension) can be contacted to the adhesive composition that is positioned on the live fingernail such that the adhesive composition that was placed on the live fingernail is contacting the artificial fingernail. The adhesive composition can then be allowed to sure such that the artificial fingernail and the live fingernail are attached to one another through the adhesive composition.

In some instances, the adhesive composition could be provided to a user with a kit or as part of a kit. The kit could contain a container holding a suitable amount of the adhesive composition as well as one or more cosmetic articles suitable for attachment to a keratin-containing substrate through the adhesive composition. The kit could contain an applicator, such as a brush or a spatula.

The adhesive compositions disclosed herein can provide a stronger bond strength than previously available adhesives. When in use, this stronger bond strength can allow for a longer wear time of a cosmetic article bonded using the adhesive composition. For example, an eyelash extension (e.g., an artificial eyelash) bonded to a live eyelash with the adhesive compositions disclosed herein can exhibit a wear time of greater than one week, greater than two weeks, or even greater than three weeks. The adhesive compositions disclosed herein can provide a stronger bond strength than previously available adhesives even under conditions that provide moisture to the adhesive bond, such as through sweat or tears.

A stronger bond strength may result in better adhesive performance for the user, e.g., a longer wear time of a cosmetic article. The adhesive compositions disclosed herein can be used for bonding a variety of cosmetic articles to a keratin-containing substrate, such as a live eyelash, hair, portion of skin, fingernail, toenail, or tooth.

### Examples

The following non-limiting examples are included to further illustrate various embodiments of the instant disclosure and do not limit the scope of the instant disclosure.

### Test Methods

### Bond Strength Test Method

The Bond Strength Test Method is as follows. The testing device is a force gauge (Series 7, from Mark-10, of Copiague, NY, USA).

To form samples to be tested, fake eyelashes are adhered to a keratin-containing substrate with an adhesive composition to be tested. Strands of live hair (i.e., not synthetically manufactured, but rather previously part of a human body) are used as a sample keratin-containing substrate.

Each strand of live hair to be used as to form a test sample is measured to give the diameter in millimeters. The strand of fake eyelash to be used to form a test sample is coated along its length (with the adhesive composition to be tested) by inserting a first end of the strand of fake eyelash into a droplet of the adhesive composition to a distance of two to four mm along the length of the strand, as measured from the first end. The strand of fake eyelash is then adhered to a strand of live hair by contacting the first end of the strand of fake eyelash (having the adhesive composition), along a length of the strand of live hair. Multiple strands of fake eyelash can be adhered along the length of the strand of live hair, with each strand of fake eyelash spaced from five to 10 millimeters apart along the strand of live hair. Each strand of fake eyelash is adhered to a strand of live hair along a length of the strand of fake eyelash about two to four mm long, and leaving a portion of the length of the strand of fake eyelash separate from the strand of live hair (to be available for handling the strand of fake eyelash). The samples for testing (having the fake eyelash in contact with the strand of live hair through the adhesive composition) are left for about two to four hours, and the adhesive composition is allowed to dry to adhere the fake eyelash to the live hair.

The fake eyelash is pulled away from the live hair in the shear direction. That is the fake eyelash is pulled in the direction having the length of the strand of fake eyelash about 180 degrees from the direction of the length of the strand of live hair. The pulling force necessary to separate the bond of the adhesive composition between the fake eyelash and the live hair is measured with a force gauge (Mark-10 M7-05) in gF unit.

The bond strength measurement is given in force per diameter using the following formula: strength (gF/mm) is equal to the pulling force (gF) divided by the diameter of the strand of live hair (mm). For every adhesive composition to be tested, at least 15 test samples are tested. The average is reported in gF/mm.

### Compositions and Results

Real human hair was obtained from LAZADA VIÊT NAM (available at https://www.lazada.vn/). The fake eyelashes used were obtained from LASHVIEW LASHES (volume individual, C13 mm 0.07, available at https://lashviewbeauty.com/).

All testing was performed in a temperature and humidity-controlled environment (about 23° C., 50% relative humidity).

Compositions of adhesive composition to be tested were formed using a base composition as a comparative example and forming sample compositions by adding additive compositions to the base composition to demonstrate the effect of the presence of the additive composition.

Table 1 shows various samples that were tested. Comp 1 and Comp 2 are comparative examples, each of which included 100 wt. % the base composition. The base composition was a formulated cyanoacrylate composition (based on ethyl-2-cyanoacrylate monomer) available under the trade designation 10MQW (from Koatsu Gas Kogyo Co, Osaka, Japan.)

Comp 3 included 99.8 wt. % of the base composition and 0.2 catechol. Generally, catechol is represented by Formula II.

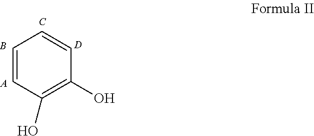

That is, with catechol, each of positions A, B, C, and D has a hydrogen atom.

The samples given in Tables 1 to 3 were tested in accordance with the test methods disclosed herein. The Bond Strength Test results of each composition is given respectively. Comp 1 was tested on the same day as samples A, B, C, and D, and Comp 2 was tested on the same day as Comp 3.

TABLE 1
Composition of Samples to be Tested

| | Wt. % in Sample | | | | | | |
|---|---|---|---|---|---|---|---|
| Component | Comp 1 | Comp 2 | Comp 3 | A | B | C | D |
| Base Composition | 100.0 | 100.0 | 99.8 | 99.8 | 99.8 | 99.8 | 99.8 |
| Catechol | | | 0.2 | | | | |
| Tannic Acid | | | | 0.2 | | | |
| Caffeic acid | | | | | 0.2 | | |
| Propyl gallate | | | | | | 0.2 | |
| 3,4-Dihydroxyhydrocinnamic acid | | | | | | | 0.2 |
| Bond Strength (gF/mm) | 126 | 130 | 110 | 207 | 205 | 177 | 197 |
| Bond Strength Increase (%) | | | | 64 | 63 | 40 | 56 |

Two each of a butyl cyanoacrylate (BCA) composition and an ethyl cyanoacrylate (ECA) composition were formed. The components of the two BCA compositions and the two ECA compositions are shown in Table 2.

TABLE 2
Composition of Cyanoacrylate Samples to be Tested

| | Wt. % in Sample | | | |
|---|---|---|---|---|
| Component | BCA 1 | BCA 2 | ECA 1 | ECA 2 |
| Butyl cyanoacrylate monomer | 93.90 | 93.40 | | |
| Ethyl cyanoacrylate monomer | | | 89.89 | 89.39 |
| Boron trifluoride diethyl etherate | | | 3.55 | 3.55 |
| premix in ethyl cyanoacrylate | | | | |
| monomer (1000 ppm) | | | | |
| Polyvinyl acetate | 6.00 | | 6.50 | |
| Polymethyl methacrylate | | 6.50 | | 7.00 |
| 18-Crown-6 solid | 0.10 | 0.10 | 0.06 | 0.06 |

The two BCA and two ECA compositions were tested using the Bond Strength Test Method. The two BCA and two ECA compositions were also used to form samples to be tested that included an additive composition (tannic acid) to show the effect of the additive composition.

The bond strength of each of the two BCA compositions and the two ECA compositions are shown in Table 3 along with samples to be tested that included each of the two BCA compositions and the two ECA compositions that included the additive composition.

TABLE 3
Composition of Samples to be Tested

| | Wt. % in Sample | | | | | | | |
|---|---|---|---|---|---|---|---|---|
| Component | E | F | G | H | I | J | K | L |
| BCA 1 | 100.0 | 99.80 | | | | | | |
| BCA 2 | | | 100.0 | 99.80 | | | | |
| ECA 1 | | | | | 100.0 | 99.90 | | |
| ECA 2 | | | | | | | 100.0 | 99.90 |
| Tannic Acid | 0 | 0.20 | 0 | 0.20 | 0 | 0.10 | 0 | 0.10 |
| Bond Strength (gF/mm) | 167 | 275 | 143 | 261 | 246 | 351* | 276 | 300* |
| Bond Strength Increase (%) | | 65 | | 83 | | 43 | | 9 |

*the strand of hair broke during the test (the bond strength was greater than the structural strength of the hair).

Regarding Samples J and L, the strand of hair broke during the test, thus it is likely that the actual bond strength is greater than the value that was able to be measured.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above-described features.

What is claimed is:

1. A method of applying a cosmetic article, the method comprising:
applying an adhesive composition to at least one of a keratin-containing substrate and a cosmetic article;
positioning the other of the keratin-containing substrate and cosmetic article in direct contact with the adhesive composition such that the keratin-containing substrate and cosmetic article are attached to one another through the adhesive composition,
the adhesive composition comprising
a cyanoacrylate composition, and
from 0.05% to five % by weight an additive composition, based on the total weight of the adhesive composition, wherein the additive composition comprises at least one substituted catechol group.

2. The method of claim 1, wherein the adhesive composition includes from 0.1% to five % by weight the additive composition, based on the total weight of the adhesive composition.

3. The method of claim 1, wherein the adhesive composition includes from 0.1% to one % by weight the additive composition, based on the total weight of the adhesive composition.

4. The method of claim 1, wherein the adhesive composition includes from 0.1% to 0.5% by weight the additive composition, based on the total weight of the adhesive composition.

5. The method of claim 1, wherein the keratin-containing substrate is at least one from the group of eyelash, hair, fingernail, toenail, tooth, and area of skin.

6. The method of claim 1, wherein the cyanoacrylate composition includes at least one monomer from the group of butyl cyanoacrylate, hexyl cyanoacrylate, ethyl cyanoacrylate, octyl cyanoacrylate, methoxyethyl cyanoacrylate, and ethoxyethyl cyanoacrylate.

7. The method of claim 1, wherein the additive composition includes at least one from the group of tannic acid, caffeic acid, propyl gallate, and 3,4-dihydroxyhydrocinnamic acid.

8. The method of claim 1, wherein the adhesive composition is configured to exhibit a bond strength of at least 130 gF/mm between the keratin-containing substrate and cosmetic article when measured in accordance with the Bond Strength Test Method.

9. The method of claim 1, wherein the cyanoacrylate composition includes monomers represented by Formula V: 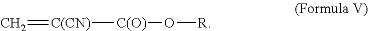
wherein “R” is at least one from the group of alkyl group, a C1-C14 substituted group, and allyl group.

10. The method of claim 9, wherein the alkyl group is at least one from the group of methyl, ethyl, propyl, butyl, pentyl, hexyl, heptyl, octyl, decyl, undecyl, decyl, dodecyl, tridecyl, tetradecyl, pentadecyl, hexadecyl, and alkoxy-alkyl group.

11. The method of claim 10, wherein alkoxy-alkyl group is at least one from the group of 2-methoxyethyl and 2-ethoxy ethyl, 3-methoxybutyl, 2-butoxyethyl, 2-isopropoxyethyl, and 1-methoxy-2-propyl.

12. A method of applying an artificial eyelash, the method comprising:
applying an adhesive composition to at least one of a natural eyelash and an artificial eyelash;
positioning the other of the natural eyelash and artificial eyelash in direct contact with the applied adhesive such that the natural eyelash and the artificial eyelash are attached to one another through the adhesive composition,
the adhesive composition comprising
a cyanoacrylate composition; and
from 0.05% to five % by weight based on the total weight of the adhesive composition, an additive comprising a substituted catechol group.

13. The method of claim 12, wherein the cyanoacrylate composition includes at least one from the group of butyl cyanoacrylate and ethyl cyanoacrylate.

14. The method of claim 12, wherein the additive includes at least one from the group of tannic acid, caffeic acid, propyl gallate, and 3,4-dihydroxyhydrocinnamic acid.

15. The method of claim 12, wherein the adhesive composition is configured to exhibit a bond strength of at least 130 gF/mm between the natural eyelash and artificial eyelash when measured in accordance with the Bond Strength Test Method.

16. The method of claim 12, wherein the cosmetic article is at least one from the group of artificial eyelash, hair extension, wig, artificial fingernail, artificial toenail, and prosthetic facial artifact.

17. An artificial lash extension system comprising:
a plurality of lash extensions, each lash extension of the plurality of lash extensions being configured to be attached to a surface of at least one natural eyelash; and
an adhesive composition comprising
a cyanoacrylate composition; and
from 0.05% to five % by weight an additive composition comprising at least one substituted catechol group, based on the total weight of the adhesive composition.

18. The artificial lash extension system of claim 17, wherein the additive composition includes at least one from the group of tannic acid, caffeic acid, propyl gallate, and 3,4-dihydroxyhydrocinnamic acid.

19. The artificial lash extension system of claim 17, wherein the cyanoacrylate composition includes at least one from the group of butyl cyanoacrylate and ethyl cyanoacrylate.

20. The artificial lash extension system of claim 17, wherein the adhesive composition is configured to exhibit a bond strength of at least 130 gF/mm between at least one lash extension of the plurality of lash extensions and at least one natural eyelash when measured in accordance with the Bond Strength Test Method.
